(19) United States
(12) Patent Application Publication
(10) Pub. No.: US 2009/0060500 A1
(43) Pub. Date: Mar. 5, 2009

(54) DATA PROCESSING SYSTEM AND STORAGE DEVICE

(75) Inventors: Shinobu Ozeki, Kanagawa (JP); Masao Funada, Kanagawa (JP); Yoshihide Sato, Kanagawa (JP); Kazuhiro Suzuki, Kanagawa (JP); Tsutomu Hamada, Kanagawa (JP); Masaru Kijima, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/055,492

(22) Filed: Mar. 26, 2008

(30) Foreign Application Priority Data
Aug. 31, 2007 (JP) 2007-225797

(51) Int. Cl. H04J 14/00; G06F 12/16

(52) U.S. Cl. 398/43; 711/161; 711/E12.103

(57) ABSTRACT

A storage device includes a memory that stores data, a memory controller that controls reading and writing of data from and to the memory, and a host controller. The host controller transmits and receives the data to and from a host via a transmission line. The host controller transmits and receives the data, via an optical transmission line, to and from (i) the memory controller and (ii) a memory controller of at least one other storage device.

### CROSS-REFERENCE TO RELATED APPLICATIONS

This application is based on and claims priority under 35 U.S.C. §119 from Japanese Patent Application No. 2007-225797 filed on Aug. 31, 2007.

### BACKGROUND

### TECHNICAL FIELD

The invention relates to a data processing system and a storage device.

### SUMMARY

According to an aspect of the invention, a data processing system includes first and second hosts, and a plurality of storage devices including first and second storage devices. The first storage device includes a first memory, a first memory controller and a first host controller. The first memory stores data transmitted from the first host. The first memory controller controls reading and writing of data from and to the first memory. The first host controller is connected to the first host via a first transmission line and transmits and receives data, via a first optical transmission line, to and from (i) the first memory controller and (ii) a memory controller of a storage device other than the first storage device. The second storage device includes a second memory, a second memory controller, and a second host controller. The second memory stores data transmitted from the second host. The second memory controller controls reading and writing of data from and to the second memory. The second host controller is connected to the second host via a second transmission line and transmits and receives data, via a second optical transmission line, to and from (i) the second memory controller and (ii) a memory controller of a storage device other than the second storage device.

### BRIEF DESCRIPTION OF THE DRAWINGS

Exemplary embodiments of the invention will be described in detail below with reference to the accompanying drawings, wherein:

FIG. 1 is a block diagram showing an example of an outline of the configuration a data processing system according to a first exemplary embodiment of the invention;

FIGS. 2A to 2C show an optical branching portion according to the first exemplary embodiment of the invention, in which FIG. 2A is a section view of a sheer-shaped optical waveguide, FIG. 2B is a perspective view of a sheet-shaped optical waveguide having a step-like shape, and FIG. 2C is a section view of an optical coupler;

FIGS. 3A to 3C show an optical multiplexing portion according to the first exemplary embodiment of the invention, in which FIG. 3A is a section view of a sheet-shaped optical waveguide, FIG. 3B is a perspective view of a sheet-shaped optical waveguide having a step-like shape, and FIG. 3C is a section view of an optical coupler;

FIG. 4 is a timing chart showing an example of data-transmission order:

FIG. 5 is a timing chart showing an example of data transmitted and received, by respective components of a storage device according to the first exemplary embodiment of the invention;

FIG. 6 is a block diagram showing an example of an outline of the configuration of a data processing system according to a second exemplary embodiment of the invention;

FIG. 7 is a timing chart showing an example of data transmitted and received by respective components of a storage device according to the second exemplary embodiment of the invention;

FIG. 8 is a block diagram showing an example of an outline of the configuration of a data processing system according to a third exemplary embodiment of the invention;

FIG. 9 is a block diagram showing an example of an outline of the configuration of a data processing system according to a fourth exemplary embodiment of the invention; and

FIG. 10 is a timing chart showing an example of data transmitted and received by respective components of a first storage device 1A according to the fourth exemplary embodiment of the invention.

### DETAILED DESCRIPTION

### [First Exemplary Embodiment]

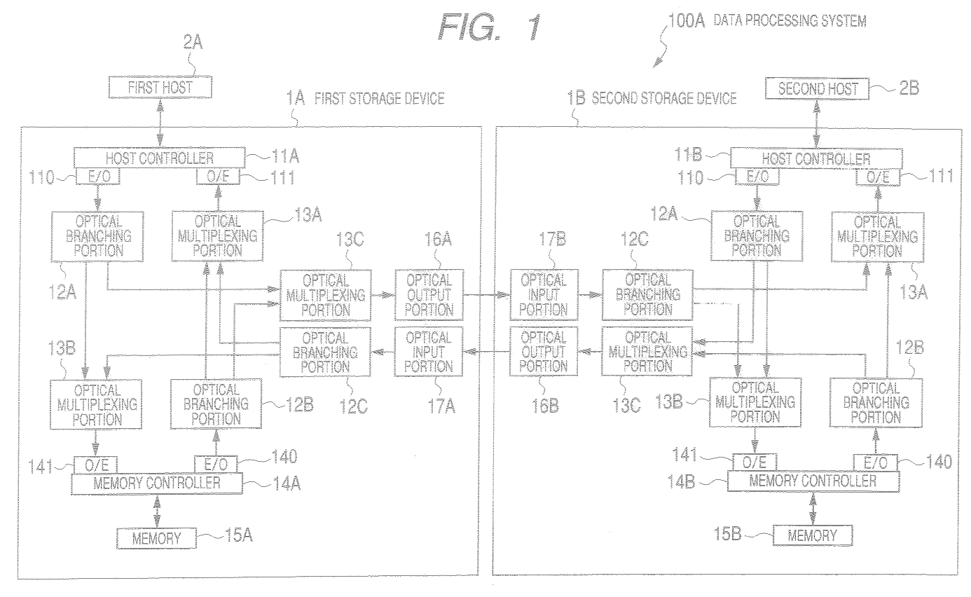

FIG. 1 is a block diagram showing an example of an outline of the configuration of a data processing system according to a first exemplary embodiment of the invention.

The data processing system 100A includes first and second storage devices 1A and 1B that are connected to first and second hosts 2A and 2B, respectively, via transmission lines. The first and second storage devices 1A and 1B are connected to each other via an optical transmission line.

The transmission lines provided between the first and second storage devices 1A and 1B and the first and second hosts 2A and 2B are configured to perform data transmission according to an interface standard such as the PCI Express (registered trademark). Also, the transmission lines may be configured to perform data transmission by electric signals or by optical signals.

The first and second hosts 2A and 2B may be servers, personal computers (PC), workstations (WS), or the like, which are devices for processing and storing data. The first and second hosts 2A and 2B may be connected to a local area network such as a wired LAN or a wireless LAN or the Internet, to transmit/receive data.

The data processing system 100A shown shown in FIG. 1 includes two hosts, that is, the first and second hosts 2A and 2B. However, the data processing system 100A may include a single host and the host may be connected to any one of the first and second storage devices 1A and 2A or may be connected to both the first and second storage devices 1A and 2A if the single host has two ports for connection to the storage devices.

The first storage device 1A includes a host controller 11A, optical branching portions 12A to 12C, optical multiplexing portions 13A to 13C, a memory controller 14A, a memory 15A, an optical output portion 16A and an optical input portion 17A. The second storage device 1B has the same construction as the first storage device 1A, and thus only the first storage device 1A will be described below.

### (Configuration of Respective Components of Storage Device)

The host controller 11A controls transmission and reception of data to and from the first host 2A.

Also, the host controller 11A includes an E/O (electric-to-optical) converting portion 110 that converts data of electric signals received from the first host 2A into optical signals at the time of transmitting the data to the memory controller 14A and the second storage device 1B, and an O/E (optical-to-electric) converting portion 111 that converts data of optical signals received from the memory controller 14A and the second storage device 1B into electric signals at the time of transmitting the data to the first host 2A.

The host controller 11A determines order in which the host controller 11A, the memory controller 14A and the second storage device 1B transmit data. This order may be referred to as “data-transmission order.”The host controller 11A performs data transmission based on the determined data-transmission order.

The memory controller 14A controls reading and writing of data from and to the memory 15A.

The memory controller 14A includes an O/E converting portion 141 that converts data of optical signals received from the host controller 11A and the second host 2B into electric signals at the time of transmitting the data to the memory 15A, and an E/O converting portion 140 that converts data of electric signals received from the memory 15A into optical signals at the time of transmitting the data to the host controller 11A and the second host 2B.

The memory controller 14A performs data transmission with the host controller 11A and the second storage device 1B, based on the data-transmission order determined by the host controller 11A.

In order to causing a mark ration (a ration of 0 and 1) of transmission signals to be close to 50%, the host controller 11A and the memory controller 14A may perform the 8B/10B conversion technique, which converts 8-bit data into 10-bit data, on transmission data.

The memory 15A is a storage medium for which reading and writing of data are performed via the memory controller 14A. As the memory 15A, a volatile semiconductor memory such as DRAM or a nonvolatile semiconductor memory such as a flash memory is suitable. The memory 15A may be a magnetic hard disk or an optical disk such as DVD.

The optical output portion 16A outputs optical signals received from the first storage device 1A, to the second storage device 1B.

The optical input portion 17A inputs optical signals received from the second storage device 1B, to the first storage device 1A.

The optical branching portions 12A to 12C are configured by a sheet-shaped optical waveguide (optical sheet bus) and/or an optical coupler, which will be described later. The optical branching portions 12A to 12C have a function of branching optical signals propagating through one optical fiber on an input side and outputting the branched optical signals to plural optical fibers on an output side.

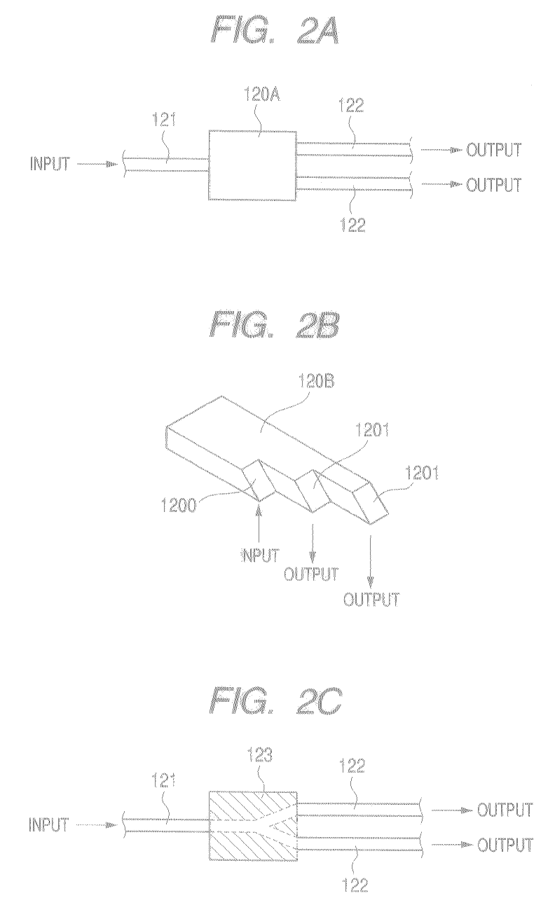

FIGS. 2A to 2C are diagrams showing an exemplary configuration of the optical branching portions 12A to 12C. A sheet-shaped optical waveguide 120A shown in FIG. 2A is a sheet-shaped waveguide and is configured to uniformly diffuse a light beam input from an optical fiber 121 to output the diffused light beams to two optical fibers 122. The sheet-shaped optical waveguide 120A is formed of a sheet-shaped transparent medium having a uniform thickness and is made, for example, of a plastic material such as polymethymetacrylate, polycarbonate, or amorphous polyolefin, or inorganic glass.

FIG. 2B shows a sheet-shaped optical waveguide 120B having a step-like shape. The sheet-shaped optical waveguide 120B is formed of the same material as that of the sheet-shaped optical waveguide 120A and is configured to uniformly diffuse a light beam, input from a 45-degree input surface 1200 to output two light beams from 45-degree output surfaces 1201.

FIG. 2C shows an optical coupler 123. The optical coupler 123 is a waveguide having a Y-shaped core and is configured to branch a light beam input from the optical fiber 121 to output the light beams to the two optical fibers 122.

The optical branching portion 12A branches optical signals transmitted from the E/O converting portion 110 of the host controller 11A into two ways, that is, ways to the memory controller 14A and the optical output portion 16A. The optical transmission line on which the optical signals transmitted from the E/O converting portion 110 are transmitted to the memory controller 14A and the optical output portion 16A through the optical branching portion 12A is referred to as a “first optical branch line.”

The optical branching portion 12B branches optical signals transmitted from the E/O converting portion 140 of the memory controller 14A into two ways, that is, ways to the host controller 11A and the optical output portion 16A. The optical transmission line on which the optical signals transmitted from the E/O converting portion 140 are transmitted to the host controller 11A and the optical output portion 16A through the optical branching portion 12B is referred to as a “second optical branch line.”

The optical branching portion 120 branches optical signals input from the second storage device 1B via the optical input portion 17A into two ways, that is, ways to the host controller 11A and the memory controller 14A. The optical transmission line on which the optical signals input from the optical input portion 17A are transmitted to the host controller 11A and the memory controller 14A through the optical branching portion 12C is referred to as a “third optical branch line.”

The optical multiplexing portions 13A to 13C are configured by a sheet-shaped optical waveguide or an optical coupler, similar to the optical branching portions 12A to 12C, and have a function of multiplexing the optical signals propagating through plural optical fibers on an input side and output the multiplexed optical signals to an optical fiber on an output side.

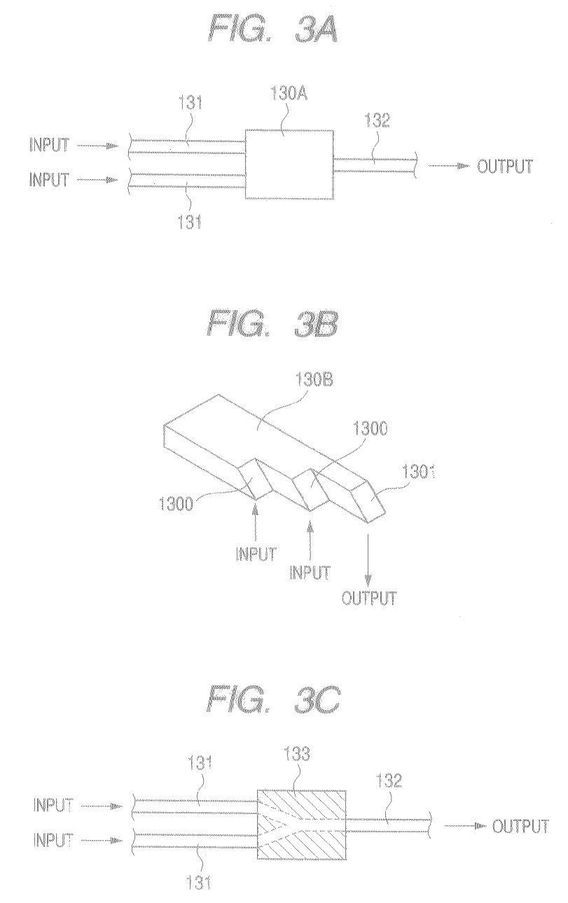

FIGS. 3A to 3C are diagrams showing an exemplary configuration of the optical multiplexing portions 13A to 13C. A sheet-shaped optical waveguide 130A shown in FIG. 3A is made of the same material as that of the sheet-shaped optical waveguide 120A shown in FIG. 2A and is configured to uniformly diffuse light beams input from two optical fibers 131, to output the diffused light beams to an optical fiber 132.

FIG. 3B shows a sheet-shaped optical waveguide 130B having a step-like shape. The sheet-shaped optical waveguide 130B is made of the same material as that of the sheet-shaped optical waveguide 120B shown in FIG. 2B and is configured to uniformly diffuse light beams input from 45-degree input surfaces 1300 and to output a single light beam from a 45-degree output surface 1301.

FIG. 3C shows an optical coupler 133. The optical coupler 133 has the same configuration as the optical coupler 123 shown in FIG. 2C and is configured to output light beams input from the optical fiber 131, to the optical fiber 132.

The optical multiplexing portion 13A multiplexes the optical signals transmitted from the memory controller 14A via the optical branching portion 12B and the optical signals input from the second storage device 1B via the optical input portion 17A, and transmits the multiplexed optical signals to the host controller 11A.

The optical multiplexing portion 13B multiplexes the optical signals transmitted from the host controller 11A via the optical branching portion 12A and the optical signals input from the second storage device 1B via the optical input portion 17A, and transmits the multiplexed optical signals to the memory controller 14A.

The optical multiplexing portion 13C multiplexes the optical signals transmitted from the host controller 11A via the optical branching portion 12A and the optical signals transmitted from the memory controller 14A via the optical branching portion 123, and transmits the multiplexed optical signals to the optical output portion 16A.

### (Operations of First Exemplary Embodiment)

Next, operations of the data processing system 100A according to the first exemplary embodiment will be described below.

### (1) Initialization Process of Storage Device

First, when power is input to the first storage device 1A, the host controller 11A of the first storage device 1A performs an initialization process to determine as to whether another storage device (other storage devices) is connected to the optical output portion 16A and the optical input portion 17A, for example, by transmitting test data to another storage device and checking as to whether an response to the test data is received.

If the host controller 11A detects that the second storage device 1B is connected thereto as another storage device, the host controller 11A and the host controller 11B of the second storage device 1B determine allocation of time lots for data transmission.

For example, the host controller 11A outputs optical signals converted by the E/O converting portion 110, as data use to determine data-transmission order, to the second storage device 1B via the optical output portion 16A and measures time at which a response to the data is received from the second storage device 13. The host controller 11A determines data-transmission order in which the host controller 11A, the memory controller 14A and the second storage device 1B transmit data, based on the measured time. Then, the host controller 11A transmits the determined data-transmission order to the memory controller 14A and the host controller 11B of the second storage device 1B.

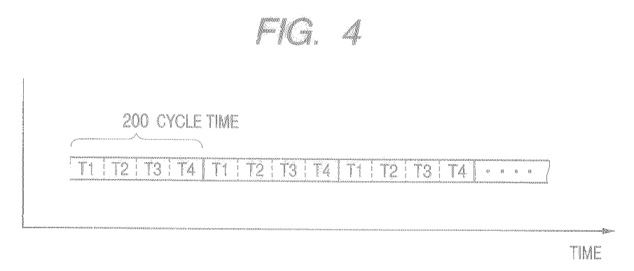

FIG. 4 is a timing chart showing an example of data-transmission order. A cycle time 200 having a predetermined cycle is divided into four time slots T1 to T4.

A time slot T1 is a time slot allocated to the host controller 11A of the first storage device 1A, and a time slot T2 is a time slot allocated to the memory controller 14A of the first storage device 1A. A time slot T3 is a time slot allocated to the host controller 11B of the second storage device, and a time slot T4 is a time slot allocated to the memory controller 14B of the second storage device 1B. Accordingly, a data transmission speed of the optical transmission line is, for example, four limes as fast as that of the transmission line between the first storage device 1A and the first host 2A, so as not to cause delay.

In addition to the initialization process for initializing data-transmission order, the host controller 11A may perform an operation of determining the data-transmission order when the first and second hosts 2A and 2B instruct to do so. In the above description, the host controller 11A transmits data used to determine the data-transmission order via optical signals. However, the data may be transmitted in the form of electric signals by providing a control line that connects the first and second storage devices 1A and 1B to each other. Moreover, the data may be transmitted via the first and second hosts 2A and 2B. Also, in the above description, data-transmission order is mainly determined by the first storage device 1A. However, data-transmission order may be mainly determined the second storage device 1B.

Also, a start switch may do provided in each of the storage devices so that each storage device can start the operation of determining data-transmission order by depressing the start switch. A setting switch for setting data-transmission order may be provided in each of the storage devices so that data-transmission order can be determined in accordance with setting states, which are set by a user, of the setting switches.

### (2) Data Transmission Between Storage Device and Host

When the first host 2A requests writing of data to the first storage device 1A, the host controller 11A of the first storage device 1A receives data to be written into the memory 15A and a write destination address that indicates a destination into which the data is to be written, from the first host 2A in the form of electric signals.

Next, during the time slot T1, the host controller 11A converts data D1 including process information representing a write request, the data to be written and the write destination address, into optical signals using the E/O converting portion 121 and transmits the converted optical signals.

The optical signals transmitted from the host controller 11A is branched by the optical branching portion 12A into two ways, and one is transmitted to the memory controller 14A via the optical multiplexing portion 13B and the other is transmitted to the optical output portion 16A via the optical multiplexing portion 13C.

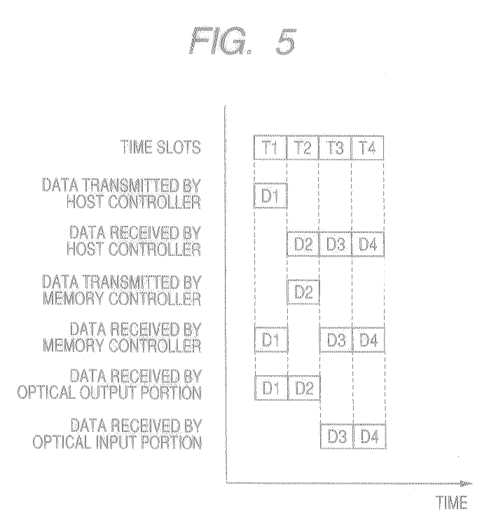

FIG. 5 is a timing chart showing an example of data transmitted and received by the respective components of the first storage device 1A. That is, during the time slot T1, the data D1 transmitted from the host controller 11A is branched by the optical branching portion 12A and transmitted to the memory controller 14A and the optical output portion 16A.

The host controller 11A may transmit data in any of the cycle times 200 so long as the host controller 11A transmits the data within the time slot T1. Also, the host controller 11A may divide the data to be written into several data components, and transmit plural data D1 including the segments of the data to be written, during respective time slots T1 in the plural cycle times 200.

When receiving the optical signals, the memory controller 14A converts the optical signals into electric signals using the O/E converting portion 141 and processes the converted data based on the process information included in the converted data. In this case, the process information of the converted data, that is, the data D1 is a write request. Thus, the memory controller 14A transmits the data to be written and the write destination address to the memory 15A, and the memory 15A stores the data to be written in the write destination address. Meanwhile, the optical output portion 16A transmits the optical signals transmitted from the hose controller 11A to the second storage device 1B as they are.

When the first host 2A requests reading of data to the first storage device 1A, the host controller 11A of the first storage device 1A receives a read destination address from the first host 2A and transmits data D1 including process information representing a read request and the read destination address to the memory controller 14A during the time slot T1.

When the memory controller 14A detects the process information of the received data D1 as a read request, the memory controller 14A reads out data corresponding to the read destination address from the memory 15A. Then, the memory controller 14A converts electric signals of data D2 including the read data into optical signals using the E/O converting portion 140, and transmits the converted optical signals, during the time slot T2.

The optical signals transmitted from the memory controller 14A is branched by the optical branching portion 12B into two ways, and one is transmitted to the host controller 11A via the optical multiplexinq portion 13A and the other is transmitted to the optical output portion 16A via the optical multiplexing portion 13C.

That is, as shown in FIG. 5, during the time slot T2, the data D2 transmitted from the memory controller 14A is branched by the optical branching portion 12B and transmitted to the host controller 11A and the optical output portion 16A.

Then, the host controller 11A acquires the data D2 by converting the optical signals received from the memory controller 14A into electric signals using the O/E converting portion 111 and transmits the read data included in the data D2 to the first host 2A. Meanwhile, the optical output portion 16A transmits the optical signals transmitted from the memory controller 14A to the second storage device 1B as they are.

Similar data transmission/reception operations are also performed between the second host 2B and the second storage device 1B. In the second storage device 1B, the optical signals are transmitted from the host controller 11B during the time slot T3, while the optical signals are transmitted from the memory controller 14B during the time slot T4.

Therefore, as shown in FIG. 5, during the time slot T3, the optical signals, which include data D3 and which are transmitted from the host controller 11B of the second storage device 1B, are also input to the first storage device 1A via the optical input portion 17A and branched by the optical branching portion 12C to be transmitted to the memory controller 14A and the host controller 11A of the first storage device 1A.

When receiving the optical signals transmitted from the host controller 11B, the host controller 11A acquires the data D3 by converting the received optical signals into electric signals using the O/E converting portion 111. For example, when the data D3 includes a request for data transmission to the first host 2A, the host controller 11A transmits the data to the first host 2A.

When receiving the optical signals transmitted from the host controller 11B, the memory controller 14A acquires the data D3 by converting the received optical signals into electric signals using the O/E converting portion 141. For example, when the data D3 includes is a write request that designates an address in the memory 15A as a write destination address of the data to be written, the memory controller 14A stores the data to be written in the designated write destination address of the memory 15A.

Next, as shown in FIG. 5, during the time slot T4, the optical signals, which include data D4 and which are transmitted from the memory controller 14B of the second storage device 1B, are input to the first storage device 1A via the optical input portion 17A and are transmitted to the memory controller 14A and the host controller 11A of the first storage device 1A via the optical branching portion 12C.

The host controller 11A and the memory controller 14A perform necessary processing for the data D4 when the host controller 11A and/or the memory controller 14A determine that it is necessary to perform the processing for the data D4, in a manner similar to the case of the data D3.

### [Second Exemplary Embodiment]

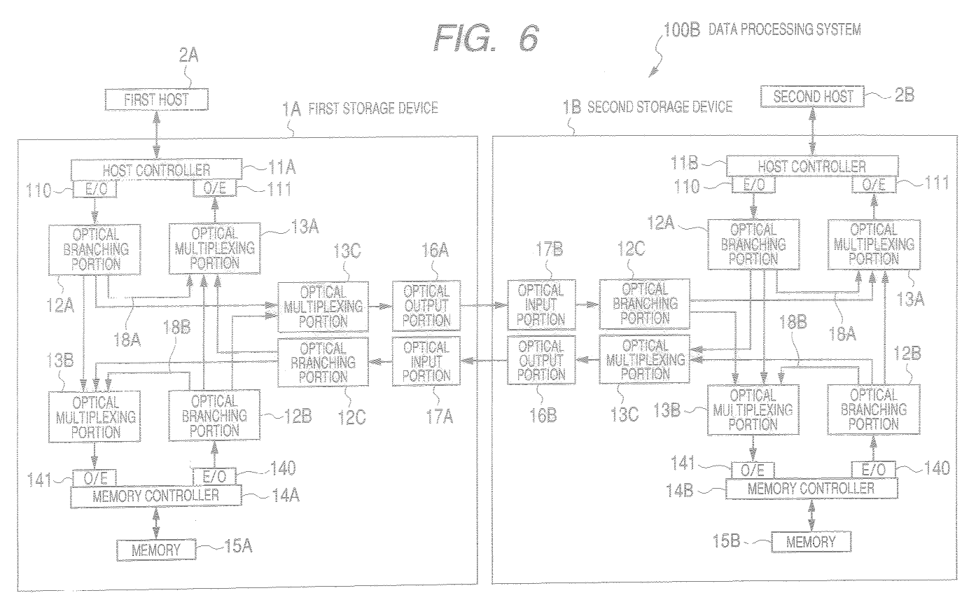

FIG. 6 is a block diagram showing an example of an outline of the configuration of a data processing system according to a second exemplary embodiment of the invention.

The first and second storage devices 1A and 1B of a data processing system 100B according to this exemplary embodiment are configured by adding, to the first and second storage devices 1A and 1B according to the first exemplary embodiment, (i) an optical fiber 18A that connects the optical branching portion 12A and the optical multiplexing portion 13A to each other and (ii) an optical fiber 18B that connects the optical branching portion 12B and the optical multiplexing portion 13B to each other. Furthermore, the optical branching portions 12A and 12B are configured to branch a single optical signal into three optical signals. Also, the optical multiplexing portions 13A and 13B are configured to multiplex three optical signals into a single optical signal.

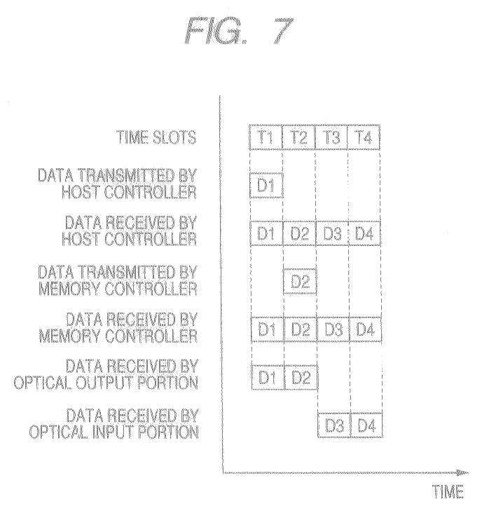

FIG. 7 is a timing chart showing an example of data transmitted and received by respective components of the first storage device 1A according to the present embodiment. Since the optical branching portion 12A of the first storage device 1A branches the optical signal into three ways, during the time slot T1, the data D1 transmitted from the host controller 11A are transmitted into three ways and the data D1 are transmitted to the memory controller 14A, the optical output portion 16A, and the host controller 11A via the optical branching portion 12A.

During the time slot T2, the data D2 transmitted from the memory controller 14A are transmitted to three ways, that is, to the host controller 11A, the optical output portion 16A, and the memory controller 14A via the optical branching portion 12B. The data D2 transmitted from the memory controller 14A are re-input (looped back) to the memory controller 14A. Thereby, signals received by the memory controller 14A don't discontinue, and it becomes possible to prevent the case in which a signal level is kept at a certain level for a long time period. Accordingly, it becomes possible to prevent transmission error.

### [Third Exemplary Embodiment]

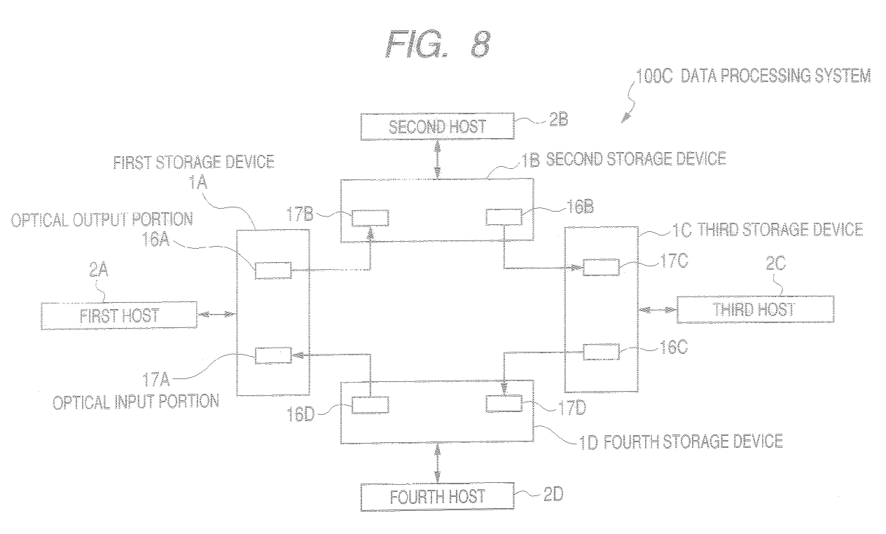

FIG. 8 is a block diagram showing an example of an outline of the configuration of a data processing system according to a third exemplary embodiment of the invention.

In a data processing system 100C, first to fourth storage devices 1A to 1D are connected to each other via optical transmission lines in a ring shape, and the first to fourth storage devices 1A to 1D are connected to first to fourth hosts 2A to 2D, respectively. The storage devices according to the first or second exemplary embodiment may be applied to the first to fourth storage devices 1A to 1D according to this exemplary embodiment.

That is, the optical output portion 16A of the first storage device 1A is connected to the optical input portion 17B of the second storage device 1B. Similarly, the optical output portion 16B of the second storage device 13 is connected to the optical input portion 17C of the third storage device 1C, the optical output portion 16C of the third storage device 1C is connected to the optical input portion 17D of the fourth storage device 1D, and the optical output portion 16D of the fourth storage device 1D is connected to the optical input portion 17A of the first storage device 1A.

Each of the host controllers of the first to fourth storage devices 1A to 1D and host controllers of the storage devices connected thereto determine data-transmission order. The host controllers and the memory controllers of the first to fourth storage devices 1A to 1D perform data transmission based on the determined data-transmission order.

When transmitting data, the host controllers and the memory controllers of the first to fourth storage devices 1A to 1D transmit the data together with a transmission destination address of the data or process information of the data.

When receiving data, the host controllers and the memory controllers of the first to fourth storage devices 1A to 1D check the transmission destination address of the data or the process information of the data, which is included in the received data, and perform a necessary process when it is determined that the data requires the process.

In FIG. 8, the first to fourth hosts 2A to 2D are connected to the first to fourth storage devices 1A to 1D, respectively. However, it is not necessary that all the storage devices are connected to the hosts. For example, the host may be connected to the first storage device 1A but not to the second to fourth storage devices 1B to 1D. Alternatively, the hosts may be connected to the first and third storage devices 1A and 1C, respectively.

When writing data from a host to the third storage device 1C in a state where the host is connected only to the first storage device 1A, the first storage device 1A acquires a write request from the host and transmits the write request as optical signals via the optical output portion 16A. Then, the second storage device 1B transmits the optical signals, which is received via the optical input portion 17B, via the optical output portion 16B. Then, the third storage device 1C receives the optical signals via the optical input portion 17C and performs a process for the write request. That is, the second storage device 1B relays the data transmitted from the first storage device 1A to the third storage device 1C.

### [Fourth Exemplary Embodiment]

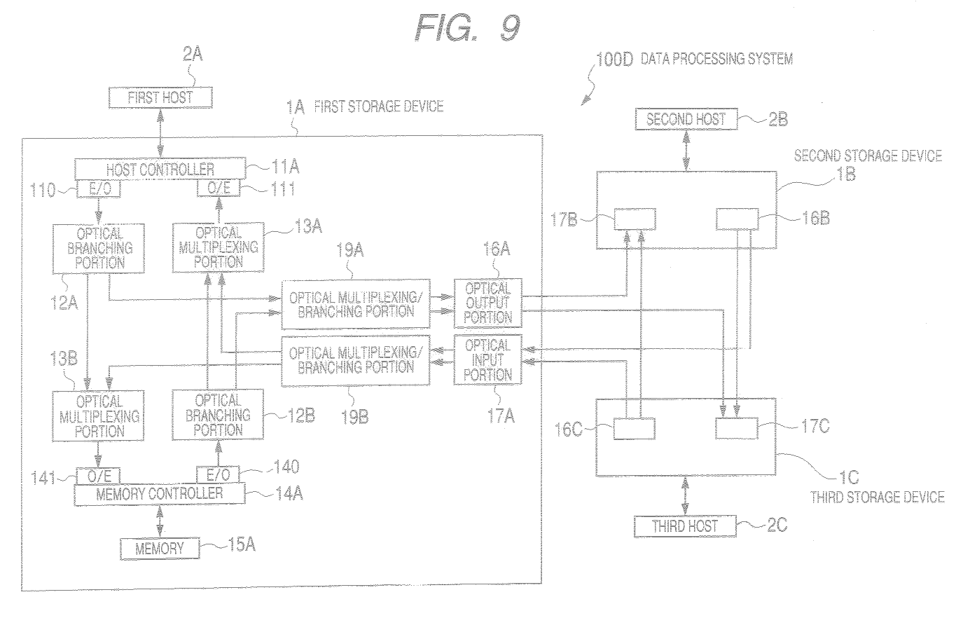

FIG. 9 is a block diagram showing an example of an outline of the configuration of a data processing system according to a fourth exemplary embodiment of the invention.

In a data processing system 100D, first to third storage devices 1A to 1C are connected to each other via optical transmission lines, and the first to third storage devices 1A to 1C are connected to first to third hosts 2A to 2C, respectively.

In comparison with the storage devices according to the first exemplary embodiment, the first storage device 1A according to this exemplary embodiment includes optical multiplexing/branching portions 19A and 19B, instead of the optical branching portion 12C and the optical multiplexing portion 13C. The optical multiplexing/branching portions 19A and 19B can receive two optical signals, and branch each received optical signal into two optical signals for output. The configuration of the storage device according to the first or second exemplary embodiment may be applied to the remaining configuration of the first storage device 1A according to the this exemplary embodiment.

The optical output portion 16A is connected to the optical input portions 17B and 17C of the second and third storage devices 1B and 1C and outputs the two optical signals, which are transmitted from the optical multiplexing/branching portion 19A.

The optical input portion 17A inputs two optical signals, which are transmitted from the second and third hosts 2B and 2C, to the optical multiplexing/branching portion 19B.

Also, the second and third storage devices 1B and 1C have the same configuration as the first storage device 1A. The optical output portion 16B of the second storage device 1B is connected to the optical input portions 17A and 17C of the first and third storage device 1A and 1C, and the optical output portion 16C of the third storage device 1C is connected to the optical input portions 17A and 17B of the first and second storage devices 1A and 1B.

Each of the host controllers of the first to third storage devices 1A to 1C and memory controllers of the storage device connected thereto determine data-transmission order. The host controllers and the memory controllers of the first to third storage devices 1A to 1C perform data transmission based on the determined data-transmission order.

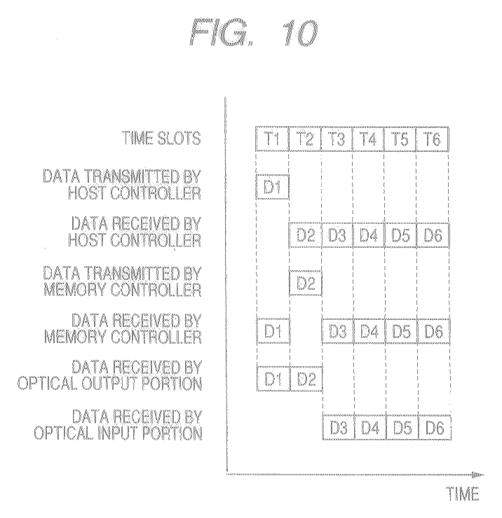

FIG. 10 is a timing chart showing an example of data transmitted and received by respective components of the first storage device 1A according to this exemplary embodiment. In the storage devices according to the first to third exemplary embodiments, the cycle time 200 is divided into four time slots. In the storage device according to this exemplary embodiment, the cycle time 200 is divided into six time slots.

The time slot T1 is allocated to the host controller 11A of the first storage device 1A. Data D1 transmitted from the host controller 11A is transmitted to the memory controller 14A and the optical multiplexing/branching portion 19A via the optical branching portion 12A.

The time slot T2 is allocated to the memory controller 14A of the first storage device 1A. Data D2 transmitted from the memory controller 14A is transmitted to the memory controller 14A and the optical multiplexing/branching portion 19A via the optical branching portion 12B.

The time slots T3 and T4 are allocated to the host controller and the memory controller of the second storage device 1B, respectively. Data D3 and D4 transmitted from the host controller and the memory controller of the second storage device 1B are transmitted to the host controller 11A and the memory controller 14A via the optical input portion 17A and the optical multiplexing/branching portion 19B.

Similarly, the time slots T5 and T6 are allocated to the host controller and the memory controller of the third storage device 1C. Data D5 and D6 transmitted from the host controller and the memory controller of the third storage device 1C are transmitted to the host controller 11A and the memory controller 14A via the optical input portion 17A and the optical multiplexing/branching portion 19B.

Then, similarly to the third exemplary embodiment, when transmitting data, the host controllers and the memory controllers of the first to third storage devices 1A to 1C transmit the data together with a transmission destination address of the data or process information of the data. When receiving data, the host controllers and the memory controllers of the first to third storage devices 1A to 1C check the transmission destination address or the process information of the data, included in the received data and perform a necessary process when it is determined that the data requires the process.

In FIG. 9, the first to third hosts 2A to 2C are connected to the first to third storage devices 1A to 1C, respectively. However, it is not necessary that all the storage devices are connected to the hosts. For example, the host may be connected to the first storage device 1A but not to the second and third storage devices 1B and 1C. Alternatively, the hosts may be connected to the first and third storage devices 1A and 1C, respectively.

When writing data from a host to the third storage device 1C in a state where the host is connected only to the first storage device 1A, the first storage device 1A acquires a write request from the host and transmits the write request as optical signals via the optical output portion 16A. Then, the third storage device 1C receives the optical signals via the optical input portion 17C and performs a process for the write request.

### [Other Exemplary Embodiments]

The invention is not limited to the exemplary embodiments described above but may be modified in various ways without departing from the spirit and scope of the invention. For example, in the above-described exemplary embodiments, transmissions of optical signals are allocated in a time-division manner. However, the optical signals transmitted by the E/O converting portions of the respective controllers may be determined such that wavelengths of the optical signals are not overlapped with each other, and the E/O converting portions transmit the optical signals having the thus-determined wavelengths. In this case, the O/E converting portions are provided with optical filters corresponding to the respective wavelengths of the optical signals separately extract optical signals of each wavelength using the optical filters to receive optical signals transmitted from the E/O converting portions.

The components of each exemplary embodiment may be arbitrarily combined with each other without departing from the spirit and scope of the invention.

What is claimed is:

1. A data processing system comprising:
first and second hosts; and
a plurality of storage devices including first and second storage devices, wherein
the first storage device includes
a first memory that stores data transmitted from the first host,
a first memory controller that controls reading and writing of data from and to the first memory, and
a first host controller that is connected to the first host via a first transmission line and transmits and receives data, via a first optical transmission line, to and from (i) the first memory controller and (ii) a memory controller of a storage device other than the first storage device, and
the second storage device includes
a second memory that stores data transmitted from the second host,
a second memory controller that controls reading and writing of data from and to the second memory, and
a second host controller that is connected to the second host via a second transmission line and transmits and receives data, via a second optical transmission line, to and from (i) the second memory controller and (ii) a memory controller of a storage device other than the second storage device.

2. The data processing system according to claim 1, wherein
the first optical transmission line of the first storage device includes
a first optical branch line extending from the first host controller toward (i) the first memory controller and (ii) the memory controller or the storage device other than the first storage device,
a second optical branch line extending from the first memory controller toward (i) the first host controller and (ii) a host controller of the storage device other than the first storage device, and
a third optical branch line extending from the storage device other than the first storage device toward (i) the first host controller and (ii) the first memory controller, and
the second optical transmission line of the second storage device includes
a fourth optical branch line extending from the second host controller toward (i) the second memory controller and (ii) the memory controller of the storage device other than the second storage device,
a fifth optical branch line extending from the second memory controller toward (i) the second host controller and (ii) a host controller of the storage device other than the second storage device, and
a sixth optical branch line extending from the storage device other than the second storage device toward (i) the second host controller and (ii) the second memory controller.

3. The data processing system according to claim 1, wherein
the first storage device includes
a first optical branch line extending from the first host controller toward (i) the first memory controller and (ii) the memory controller of the storage device other than the first storage device,
a second optical branch line extending from the first memory controller toward (i) the first host controller and (ii) a host controller of the storage device other than the first storage device, and
a third optical branch line extending from a storage device, that is different from (i) the storage device other than the first storage device and (ii) the storage device other than the second storage device, toward (i) the first host controller and (ii) the first memory controller, and
the second storage device includes
a fourth optical branch line extending from the second host controller toward (i) the second memory controller and (ii) the memory controller of the storage device other than the second storage device,
a fifth optical branch line extending from the second memory controller toward (i) the second host controller and (ii) a host controller of the storage device other than the second storage device, and
a sixth optical branch line extending from a storage device, that is different from (i) the storage device other than the first storage device and (ii) the storage device other than the second storage device, toward (i) the second host controller and ii) the second memory controller.

4. The data processing system according to claim 2, further comprising:
a first shared optical transmission line that is shared by (i) an optical transmission line of the first optical branch line of the first storage device, which extends toward the memory controller of the storage other than the first storage device, and (ii) an optical transmission line of the second optical branch line of the first storage device, which extends toward the memory controller of the storage device other than the first storage device, and
a second shared optical transmission line that is shared by (i) an optical transmission line of the fourth optical branch line of the second storage device, which extends toward the memory controller of the storage device other than the second storage device, and (ii) an optical transmission line of the fifth optical branch line of the second storage device, which extends toward the memory controller of the storage device other than the second storage device.

5. The data processing system according to claim 4, wherein
the first host controller transmits the data to the first optical branch line based on data-transmission order that is determined so that (i) the data transmitted from the first host controller and the data transmitted from the first memory controller are not overlapped with each other in the first shared optical transmission line and (ii) the data transmitted from the second host controller and the data transmitted from the second memory controller are not overlapped with each other in the second shared optical transmission line,
the first memory controller transmits the data to the second optical branch line based on the data-transmission order,
the second host controller transmits the data to the fourth optical branch line based on the data-transmission order, and
the second memory controller transmits the data to the fifth optical branch line based on the data-transmission order.

6. The data processing system according to claim 3, further comprising:
a first shared optical transmission line that is shared by (i) an optical transmission line of the first optical branch line of the first storage device, which extends toward the memory controller of the storage device other than the first storage device, and (ii) an optical transmission line of the second optical branch line of the first storage device, which extends toward the memory controller of the storage device other than the first storage device, and
a second shared optical transmission line that is shared by (i) an optical transmission line of the fourth optical branch line of the second storage device, which extends toward the memory controller of the storage device other than the second storage device, and (ii) an optical transmission line of the fifth optical branch line of the second storage device, which extends toward the memory controller of the storage device other than the second storage device.

7. The data processing system according to claim 6, wherein
the first host controller transmits the data to the first optical branch line based on data-transmission order that is determined so that (i) the data transmitted from the first host controller and the data transmitted from the first memory controller are not overlapped with each other in the first shared optical transmission line and (ii) the data transmitted from the second host controller and the data transmitted from the second memory controller are not overlapped with each other in the second shared optical transmission line,
the first memory controller transmits the data to the second optical branch line based on the data-transmission order,
the second host controller transmits the data to the fourth optical branch line based on the data-transmission order, and
the second memory controller transmits the data to the fifth optical branch line based on the data-transmission order.

8. The data processing system according to claim 2, further comprising:
a first shared optical transmission line shared by (i) an optical transmission line of the first optical branch line of the first storage device, which extends toward the memory controller of the storage device other than the first storage device, and (ii) an optical transmission line of the second optical branch line of the first storage device, which extends toward the memory controller of the storage device other than the first storage device;
a second shared optical transmission line shared by (i) an optical transmission line of the first optical branch line of the first storage device, which extends toward the first memory controller, and (ii) an optical transmission line of the third optical branch line of the first storage device, which extends toward the first memory controller;
a third shared optical transmission line shared by (i) an optical transmission line of the second optical branch line of the first storage device, which extends toward the first host controller, and (ii) an optical transmission line of the third optical branch line of the first storage device, which extends toward the first host controller;
a fourth shared optical transmission line shared by (i) an optical transmission line of the fourth optical branch line of the second storage device, which extends toward the memory controller of the storage device other than the second storage device, and (ii) an optical transmission line of the fifth optical branch line of the second storage device, which extends toward the memory controller of the storage device other than the second storage device;
a fifth shared optical transmission line shared by (i) an optical transmission line of the fourth optical branch line of the second storage device, which extends toward the second memory controller, and (ii) on optical transmission line of the sixth optical branch line of the second storage device, which extends toward the second memory controller;
a sixth shared optical transmission line shared lay (i) an optical transmission line of the fifth optical branch line of the second storage device, which extends toward the second host controller, and (ii) an optical transmission line of the sixth optical branch line of the second storage device, which extends toward the second host controller.

9. The data processing system according to claim 8, wherein
the first host controller transmits the data to the first optical branch line based on data-transmission order that is determined so that (a) (i) the data transmitted from the first host controller, (ii) the data transmitted from the first memory controller and (iii) the data transmitted from the storage device other than the first storage device to the first host controller and the first memory controller are not overlapped with each other in any of the first to third shared optical transmission line and (b) (i) the data transmitted from the second host controller, (ii) the data transmitted from the second memory controller and (iii) the data transmitted from the storage device other than the second storage device to the second host controller and the second memory controller are not overlapped with each other in any of the fourth to sixth shared optical transmission line,
the first memory controller transmits the data to the second optical branching line based on the data-transmission order,
the storage device other than the first storage device transmits the data to the third optical branching line based on the data-transmission order,
the second host controller transmits the data to the fourth optical branch line based on the data-transmission order,
the second memory controller transmits the data to the fifth optical branching line based on the data-transmission order, and
the storage device other than the second storage device transmits the data to the sixth optical branching line based on the data-transmission order.

10. The data processing system according to claim 3, further comprising:
a first shared optical transmission line shared by (i) an optical transmission line of the first optical branch line of the first storage device, which extends toward the memory controller of the storage device other than the first storage device, and (ii) an optical transmission line of the second optical branch line of the first storage device, which extends toward the memory controller of the storage device other than the first storage device;
a second shared optical transmission line shared by (i) an optical transmission line of the first optical branch line of the first storage device, which extends toward the first memory controller, and (ii) an optical transmission line of the third optical branch line of the storage device, which extends toward the first memory controller;
a third shared optical transmission line shared by (i) an optical transmission line of the second optical branch line of the first storage device, which extends toward the first host controller, and (ii) an optical transmission line of the third optical branch line of the first storage device, which extends toward the first host controller;
a fourth shared optical transmission line shared by (i) an optical transmission line of the fourth optical branch line of the second storage device, which extends toward the memory controller of the storage device than the second storage device, and (ii) an optical transmission line of the fifth optical branch line of the second storage device, which extends toward the memory controller of the storage device other than the second storage device;
a fifth shared optical transmission line shared by (i) an optical transmission line of the fourth optical branch line of the second storage device, which extends toward the second memory controller, and (ii) an optical transmission line of the sixth optical branch line of the second storage device, which extends toward the second memory controller;
a sixth shared optical transmission line shared by (i) an optical transmission line of the fifth optical branch line of the second storage device, which extends toward the second host controller, and (ii) an optical transmission line of the sixth optical branch line of the second storage device, which extends toward the second host controller.

11. The data processing system according to claim 10, wherein
the first host controller transmits the data to the first optical branch line based on data-transmission order that is determined so that (a) (i) the data transmitted from the first host controller, (ii) the data transmitted from the first memory controller and (iii) the data transmitted from the storage device other than the first storage device to the first host controller and the first memory controller are not overlapped with each other in any of the first to third shared optical transmission line and (b) (i) the data transmitted from the second host controller, (ii) the data transmitted from the second memory controller and (iii) the data transmitted from the storage device other than the second storage device to the second host controller and the second memory controller are not overlapped with each other in any of the fourth to sixth shared optical transmission line,
the first memory controller transmits the data to the second optical branching line based on the data-transmission order,
the storage device other than the first storage device transmits the data to the third optical branching line based on the data-transmission order,
the second host controller transmits the data to the fourth optical branch line based on the data-transmission order,
the second memory controller transmits the data to the fifth optical branching line based on the data-transmission order, and
the storage device other than the second storage device transmits the data to the sixth optical branching line based on the data-transmission order.

12. The data processing system according to claim 1, wherein the first and second hosts are separate from each other.

13. The data processing system according to claim 1, wherein
the first host controller transmits and receives the data to and from (i) the first memory controller and (ii) the second memory controller of the second storage device, and
the second host controller transmits and receives data to and from (i) the second memory controller and (ii) the first memory controller.

14. A storage device comprising:
a memory that stores data:
a memory controller that controls reading and writing of data from and to the memory; and
a host controller that transmits and receives the data to and from a host via a transmission line, the host controller that transmits and receives the data, via an optical transmission line, to and from (i) the memory controller and (ii) a memory controller of at least one other storage device.

15. The storage device according to claim 14, further comprising:
a first optical branch line extending from the host controller toward (i) the memory controller and (ii) the memory controllers of the at least one other storage device;
a second optical branch line extending from the memory controller toward (i) the host controller and (ii) a host controller of the at least one other storage device; and
a third optical branch line extending from the at least one other storage device toward (i) the host controller and (ii) the memory controller.

16. The storage device according to claim 14, further comprising:
a first optical branch line extending from the host controller toward (i) the memory controller and (ii) the memory controller of the a least one other storage device;
a second optical branch line extending from the memory controller toward (i) the host controller and (ii) a host controller of the at least one other storage device; and
a third optical branch line extending from a further another storage device different from the storage devices, to which the first and second optical branch lines are connected, toward the host controller and the memory controller.
